(19) United States
(12) Patent Application Publication
(10) Pub. No.: US 2023/0040796 A1
(43) Pub. Date: Feb. 9, 2023

(54) DEVICE FOR CONFINING REACTOR CORE MELT

(71) Applicants: JOINT-STOCK COMPANY "ATOMENERGOPROEKT", Moscow (RU); SCIENCE AND INNOVATIONS - NUCLEAR INDUSTRY SCIENTIFIC DEVELOPMENT, PRIVATE ENTERPRISE, Moscow (RU)

(72) Inventors: ALEKSANDR STALEVICH SIDOROV, Moscow (RU); TATYANA YAROPOLKOVNA DZBANOVSKAYA, Moscow (RU); NADEZHDA VASILIEVNA SIDOROVA, Moscow (RU)

(73) Assignees: JOINT-STOCK COMPANY "ATOMENERGOPROEKT", Moscow (RU); SCIENCE AND INNOVATIONS - NUCLEAR INDUSTRY SCIENTIFIC DEVELOPMENT, PRIVATE ENTERPRISE, Moscow (RU)

(21) Appl. No.: 17/619,130

(22) PCT Filed: Dec. 29, 2020
(86) PCT No.: PCT/RU2020/000766

§ 371 Date: Dec. 14, 2021

(30) Foreign Application Priority Data
Mar. 13, 2020 (RU) 2020110765

(51) Int. Cl. G21C 15/18; G21C 9/016

(52) U.S. Cl. CPC G21C 15/18; G21C 9/016

(57) ABSTRACT

The invention is applicable to the corium localizing and cooling systems of a nuclear reactor designed for localization of severe beyond design-basis accidents, in particular, to the devices for directing corium of a nuclear reactor to the corium trap. The technical result of the claimed invention is to increase the efficiency of localization and cooling of the nuclear reactor core melt.

The goal of the invention is to eliminate the guide assembly failure due to the concentration of impact load in the conical part of the guide assembly and, therefore, the instantaneous penetration of the core, fragments of the reactor vessel internals and the reactor vessel head into the core catcher.

According to the claimed invention, the guide assembly of the nuclear reactor corium localizing and cooling system installed under the reactor vessel and supported on the cantilever truss contains a cylindrical part, a conical part with an opening made in it, with their walls covered with heat-resistant and fusible material and divided into sectors by bearing ribs arranged radially relative to the opening, and a bearing frame consisting of the outer upper bearing ring, the outer lower bearing ring, the inner bearing shell, the outer upper bearing shell, the middle bearing shell divided into sectors by bearing ribs, the outer lower bearing shell, support ribs, base, upper inclined plate connecting the conical head, bearing ribs and the middle bearing shell, lower inclined plate connecting the conical head, bearing ribs, the middle bearing shell and the outer upper bearing shell.

3 claims, 4 figures of drawings

### TECHNICAL FIELD OF THE INVENTION

The invention is applicable to the corium localizing and cooling systems of a nuclear reactor designed for localization of severe beyond design-basis accidents, in particular, to the devices for directing corium of a nuclear reactor to the corium trap.

The accidents with core meltdown, which may take place during multiple failure of the core cooling system, constitute the greatest radiation hazard.

During such accidents the core melt—corium—by melting the core structures and reactor pressure vessel, flows out beyond its limits, and as a consequence of the decay heat retained in it may disturb the NPP containment integrity—the last barrier on the escape routes of radioactive products to the environment.

It is required to localize corium escaping from the reactor pressure vessel for excluding this, and provide its continuous cooling up to complete crystallization of all the corium components. The corium trap performs this function, which after entry of corium into it prevents the NPP containment damage, thereby protecting the public and environment against radiation impact during severe accidents of the nuclear reactors by cooling and subsequent crystallization of corium.

After the reactor vessel rupture corium enters the guide assembly, which is usually executed in funnel shape installed on the cantilever truss, and designed for changing the corium movement direction from the place of its escape from the reactor pressure vessel towards the reactor cavity axis for guaranteed input of corium to the maintenance platform. By burning the service platform, corium enters into the corium trap, where it enters into interaction with the filler by gradually heating the corium trap casing. In this case, when the reactor vessel is burnt, the head of reactor vessel can tear off completely, causing the reactor vessel head to fall on the guide assembly, which will result in a high impact load on the latter. Insufficient strength of the guide assembly can cause it to be damaged on the side of the vessel head, and the simultaneous fall of the fragments of the guide assembly, core melt, internals and vessel head into the core catcher. At the initial stage of melt inflow into the filler, when the filler is intact, the fall of the detached vessel head with the core melt into the core catcher body can lead to partial blocking of the filler and destruction of the thermal shields by the core melt, as a result of melt spilling out of the detached vessel head when the vessel head hits the filler. The hydrodynamic effects of such a splashdown on the core catcher equipment can be focused in both the azimuthal and axial planes, as a result of rotating the detached reactor vessel head during accelerated motion. The impact of the vessel head against the filler as a result of the head rotation can occur in a limited sector of the filler, which will slow down and stop the vessel head, but will not be able to counteract the focusing of the core melt, when the melt spills out of the elliptical head's bowl towards the thermal shield and other catcher equipment while the head is braking. With such melt impact on the catcher equipment in a limited sector, significant damage to the equipment in excess of the design failures is possible, leading to beyond-design operation of the filler and failure of the core catcher. Due to the fact that the focused impact of the melt on the catcher equipment is hardly predictable, with its results depending on many factors that are difficult to account for, such as the rotation angle of the head at the moment of impact with the filler, the time of the head braking with the filler and characteristics of this braking, the volume of melt in the head upon impact with the filler and its characteristics, etc., the fall of the detached reactor vessel head into the filler should be excluded from the design to avoid interference in the melt localization and cooling processes.

### PRIOR ART

The guide assembly [1] (RF Patent No. 2253914, priority dated Aug. 18, 2003) of the nuclear reactor corium localizing and cooling system installed below the reactor pressure vessel head and resting on the cantilever truss executed in funnel form comprising of the cylindrical and conical parts, surfaces thereof are covered with heat-resistant concrete, apertures made in the center of the conical part is well-known.

The weak point of the guide assembly is that it has no redistribution (alignment) mechanism for static and dynamic loads. If the impact load from the torn-off reactor vessel head with the core melt or the torn-off sectors of the destroyed reactor head is applied to the guide assembly, given the acceleration generated by the residual pressure inside the reactor vessel, the main impact load is concentrated in its conical part, which can result in its destruction and an instantaneous ingress of the core melt into the core catcher. Instantaneous ingress of the core melt, in its turn, leads to a decreased efficiency of melt cooling due to the fact that the fall of the torn off vessel head with core melt into the catcher body can lead to partial blocking of the filler (made of a basket with cartridges, with the core melt diluent briquettes installed inside the latter) and destruction of the thermal shields and the water-cooled catcher circuit by the core melt, as a result of melt spilling out of the detached vessel head when it hits the filler. The hydrodynamic effects of such a splashdown on the core catcher equipment can be focused in both the azimuthal and axial planes, as a result of rotating the detached reactor vessel head during accelerated motion. The impact of the vessel head against the filler as a result of the head rotation can occur in a limited sector of the filler, which will slow down and stop the vessel head, but will not be able to counteract the focusing of the core melt, when the melt spills out of the elliptical head's bowl towards the thermal shield and other catcher equipment while the head is braking. With such melt impact on the catcher equipment in a limited sector, significant damage to the equipment in excess of the design values is possible, leading to beyond-design operation of the filler, destruction of the water-cooled circuit, which leads to the core catcher failure.

There is a known guide assembly [2] (Core catcher, NPP with VVER Safety, 7th International Academic Workshop, OKB Gidropress, Podolsk, Russia, May 17-20, 2011) of the corium localizing and cooling system, which consists of a cylindrical part and a conical part with an opening in the center, bearing ribs running from the central opening to the boundary of the cylindrical part.

The weak point of the guide assembly is that it has no redistribution (alignment) mechanism for static and dynamic loads. If the impact load from the torn-off reactor vessel head with the core melt or the torn-off sectors of the destroyed reactor head is applied to the guide assembly, given the acceleration generated by the residual pressure inside the reactor vessel, the main impact load is concentrated in its conical part, which can result in its destruction and an instantaneous ingress of the core melt into the core catcher, followed by the loss of melt localization and cooling. Instantaneous ingress of the core melt, in its turn, leads to a decreased efficiency of melt cooling due to the fact that the fall of the torn off vessel head with core melt into the catcher body can lead to partial blocking of the filler and destruction of the thermal shields and the water-cooled catcher circuit by the core melt, as a result of melt spilling out of the detached vessel head when it hits the filler. The hydrodynamic effects of such a splashdown on the core catcher equipment can be focused in both the azimuthal and axial planes, as a result of rotating the detached reactor vessel head during accelerated motion. The impact of the vessel head against the filler as a result of the head rotation can occur in a limited sector of the filler, which will slow down and stop the vessel head, but will not be able to counteract the focusing of the core melt, when the melt spills out of the elliptical head's bowl towards the thermal shield and other catcher equipment while the head is braking. With such melt impact on the catcher equipment in a limited sector, significant damage to the equipment in excess of the design failures is possible, leading to beyond-design operation of the filler and failure of the core catcher.

The closest invention to the claimed one is a guide assembly [3, 4, 5] [RF patent No. 2576516, priority on Dec. 16, 2014; RF patent No. 2576517, priority on December 16, 2014; RF patent No. 2575878, priority on Dec. 16, 2014] of the nuclear reactor corium localizing and cooling system, which consists of a cylindrical part and a conical part with an opening in the center, bearing ribs running from the central opening to the upper edge of the cylindrical part and dividing the cylindrical and conical parts into sectors covered by layers of sacrificial and heat-resistant concrete.

Such a guide assembly is designed for directing corium (melt) after damage or melt-through of reactor to the corium trap, retention of large-sized debris of the reactor internals, fuel assemblies and reactor pressure vessel head against fall of corium into the trap, protection of the cantilever-truss and its communications against damage on corium input from the reactor pressure vessel to the core catcher, guarding the reactor pit against direct contact with corium.

The bearing ribs hold down the reactor pressure vessel casing with corium that does not allow the head in the process of its damage or severe plastic deformation to overlap the cross-sections of the sectors and violate the corium trickling process.

The weak point of the guide assembly is that it has no redistribution (alignment) mechanism for static and dynamic loads. If the impact load from the torn-off reactor vessel head with the core melt or the torn-off sectors of the destroyed reactor head is applied to the guide assembly, given the acceleration generated by the residual pressure inside the reactor vessel, the main impact load is concentrated in its conical part, which can result in its destruction and an instantaneous ingress of the core melt into the core catcher, followed by the loss of melt localization and cooling. Instantaneous ingress of the core melt, in its turn, leads to a decreased efficiency of melt cooling due to the fact that the fall of the torn off vessel head with core melt into the catcher body can lead to partial blocking of the filler and destruction of the thermal shields and the water-cooled catcher circuit by the core melt, as a result of melt spilling out of the detached vessel head when it hits the filler. The hydrodynamic effects of such a splashdown on the core catcher equipment can be focused in both the azimuthal and axial planes, as a result of rotating the detached reactor vessel head during accelerated motion. The impact of the vessel head against the filler as a result of the head rotation can occur in a limited sector of the filler, which will slow down and stop the vessel head, but will not be able to counteract the focusing of the core melt, when the melt spills out of the elliptical head's bowl towards the thermal shield and other catcher equipment while the head is braking. With such melt impact on the catcher equipment in a limited sector, significant damage to the equipment in excess of the design failures is possible, leading to beyond-design operation of the filler and failure of the core catcher.

### DISCLOSURE OF THE INVENTION

The technical result of the claimed invention is to increase the efficiency of localization and cooling of the nuclear reactor core melt. The goal of the invention is to eliminate the guide assembly failure due to the concentration of impact load in the conical part of the guide assembly and, therefore, the instantaneous penetration of the core, fragments of the reactor vessel internals and the reactor vessel head into the core catcher.

The goal is achieved by the fact that the guide assembly (1) of the nuclear reactor corium localizing and cooling system installed under the reactor vessel and resting on the cantilever truss, containing a cylindrical part (2), a conical part (3) with an opening (4) made in it, with walls covered with heat-resistant and fusible material and divided into sectors by bearing ribs (5) arranged radially relative to the opening (4), according to the invention, also comprises a bearing frame consisting of an outer upper bearing ring (6), an outer lower bearing ring (7), an inner bearing shell (8), an outer upper bearing shell (9), a middle bearing shell (10) divided into sectors by bearing ribs (5), outer lower bearing shell (11), support ribs (12), base (26), upper inclined plate (13) connecting conical head (15), bearing ribs (5) and middle bearing shell (10), lower inclined plate (14) connecting conical head (15), bearing ribs (5), middle bearing shell (10) and outer upper bearing shell (9).

Also according to the invention, there is an additional inclined plate installed between the upper inclined plate (13) and the lower inclined plate (14) in the guide assembly (1) of the nuclear reactor corium localizing and cooling system.

Also according to the invention, the guide assembly (1) of the nuclear reactor corium localizing and cooling system additionally contains 1 to 2 middle bearing shells (10).

A distinguishing characteristic of the claimed invention is the use, as part of the guide assembly of the nuclear reactor corium localizing and cooling system, of a bearing frame consisting of an outer upper bearing ring (6), an outer lower bearing ring (7), an inner bearing shell (8), an outer upper bearing shell (9), a middle bearing shell (10), divided into sectors by bearing ribs (5), the outer bottom bearing shell (11), support ribs (12), base (26), the upper inclined plate (13) connecting the conical head (15), bearing ribs (5) and the middle bearing shell (10), the lower inclined plate (14) connecting the conical head (15), the bearing ribs (5), the middle bearing shell (10) and the outer upper bearing shell (9).

This guide assembly design allows for the gradual flow of corium (melt) after a reactor failure or melt-through into the core-catcher and keeps large fragments of reactor internals, fuel assemblies, and reactor vessel head from falling into the core catcher body.

Another distinguishing characteristic of the claimed invention is that an additional inclined plate is installed between the upper inclined plate (13) and the lower inclined plate (14), whose destruction along with the destruction of the upper and lower inclined plates provides a given direction of molten core flow from the reactor vessel (17) into the core catcher.

Another distinguishing characteristic of the claimed invention is the presence of 1 to 2 additional middle bearing shells (10), which protects the outer upper bearing shell (9) from destruction by the core melt, and, therefore, protects the structural and serpentine concretes of the reactor cavity from interaction with the melt.

### BRIEF DESCRIPTION OF DRAWINGS

FIG. 1 shows the guide assembly of the nuclear reactor corium localizing and cooling system, represented in cross-sectional view along the bearing ribs.

FIG. 2 shows the guide assembly of the nuclear reactor corium localizing and cooling system, represented in cross-sectional view in between the ribs.

FIG. 3 shows the guide assembly of the reactor corium localizing and cooling system, in case of tearing of the reactor vessel head and its falling on the bearing ribs of the guide assembly parallel to the axial axis of the reactor vessel.

FIG. 4 shows the guide assembly of the reactor corium localizing and cooling system, in case of tearing of the reactor vessel head and its falling on the bearing ribs of the guide assembly at an angle to the axial axis of the reactor vessel.

### EMBODIMENT OF THE INVENTION

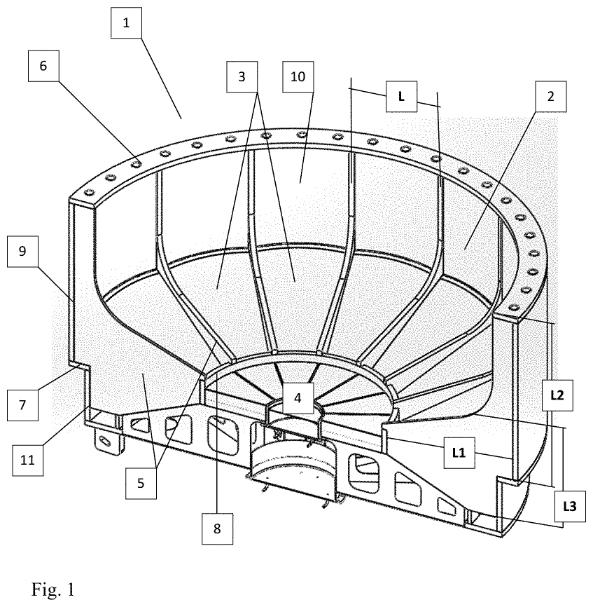

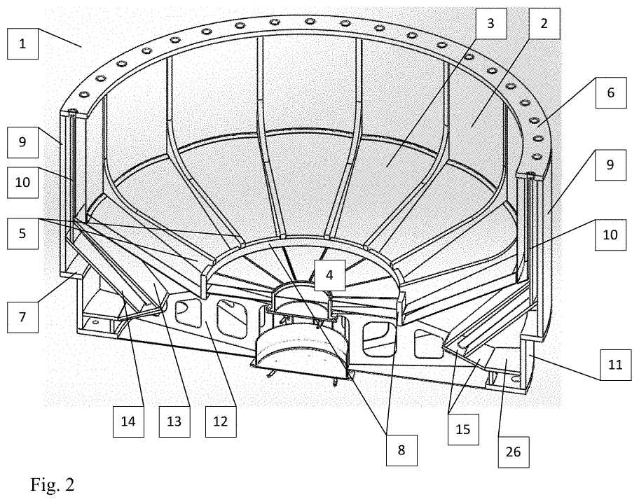

As shown in FIGS. 1 and 2, the guide assembly (1) of the corium localizing and cooling system is mounted under the reactor vessel and rests on the cantilever truss. The device (1) contains a cylindrical part (2) and a conical part (3). In the cylindrical and conical parts (2, 3) there are bearing ribs (5) arranged radially relative to the central opening (4) made in the conical part (3). The bearing ribs (5) run from the central opening (4) to the top edge of the cylindrical part (2). The central opening (4) has an inner bearing shell (8). The upper edge of the cylindrical part (2) has an outer upper bearing ring (6) to which an outer upper bearing shell (9) is attached, which connects the outer upper bearing ring (6) to the outer lower bearing ring (7), which is supported by the outer lower bearing shell (11). There is a middle bearing shell (10) between the outer bearing shell (9) and the cylindrical part (2), which connects the outer upper bearing ring (6) with the upper and lower inclined plates (13, 14). The bearing ribs (5) are installed in such a way that they divide the cylindrical part (2) and the conical part (3) into sectors. Together, the bearing ribs (5), the outer upper bearing ring (6), the outer upper bearing shell (9), the outer lower bearing ring (7), the outer lower bearing shell (11), and the inner bearing shell (8) are bonded together to form the supporting structure of the guide assembly (1). A conical head (15) with support ribs (12) connected to bearing ribs (5), outer upper bearing shell (9) and middle bearing shell (10) by means of an upper inclined plate (13) and a lower inclined plate (14), respectively, is installed in the lower part of the guide assembly (1).

The guide assembly operates as follows.

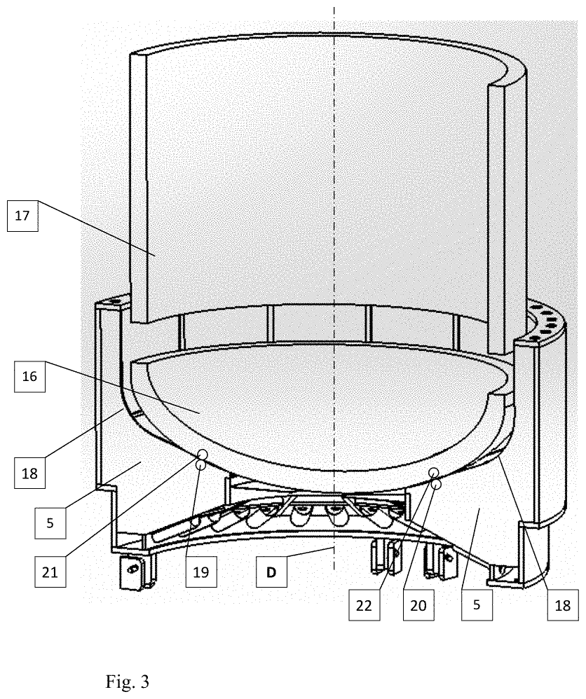

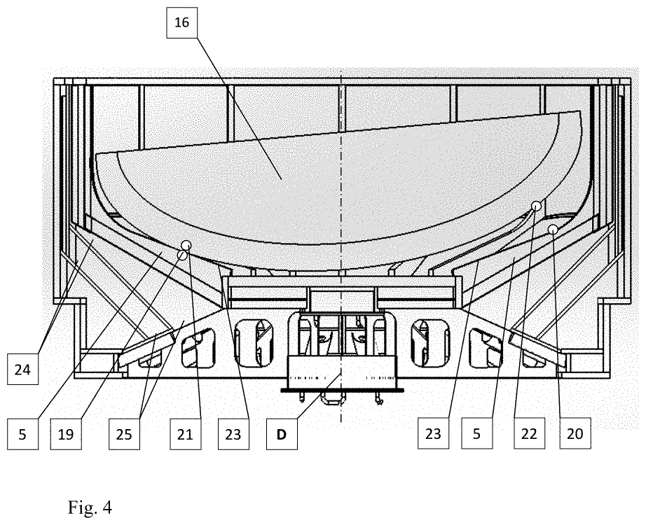

As shown in FIGS. 3 and 4, if the head (16) of the reactor vessel (17) tears off and falls on the guide assembly (1), e.g. at an angle (with an offset) to the axial axis

(D-axis) of the reactor vessel (17), the bearing frame used as part of the guide assembly (1) of the nuclear reactor corium localizing and cooling system performs anti-shock, stabilizing, channel-forming and protective functions in case of core melt leakage from reactor vessel (17) or reactor vessel (17) head (16) falling with part of core melt or head debris and debris of internals.

The shock-absorbing functions of the bearing frame are performed by the bearing ribs (5), which provide damping of the shock load from the reactor vessel (17) head (16) that detached with the core melt or from the detached sectors of the destroyed reactor head, given the acceleration generated by the residual pressure inside the reactor vessel (17).

The position of the bearing ribs (5) to perform the shock absorbing functions should be as close as possible to the reactor vessel head(16) (17), in this case the force of the impact of reactor vessel head (16) with the core melt in it or head fragments against the bearing ribs (5) will be minimal As the distance between the bearing ribs (5) and the head (16) of reactor vessel (17) increases, the impact force increases significantly and the load applied on the bearing ribs (5) is redistributed as follows: at the minimum distance, the non-uniform tear-off of the reactor vessel head (16) or its parts has little effect on the difference of mechanical loading experienced by the bearing ribs (5), these loads are approximately equal; as the distance increases, the difference in mechanical loading of the bearing ribs (5) starts growing, and if the distance between the bearing ribs (5) and the reactor vessel (17) head (16) is large, the shock load can fall entirely on one or two bearing ribs (5), which is associated with the rotation of the reactor vessel (17) head (16) during its movement due to the initial non-uniform (non-instantaneous) separation of the head (16) in the azimuthal direction from the reactor vessel (17).

The first optimum distance between the head (16) of reactor vessel (17) and the bearing ribs (5) for dampening the shock load at the first touch of the head or its parts is 50 to 250 mm. The minimum value limitation is determined by the thermal expansion of the reactor vessel (17) during normal operation, and the maximum value limitation is determined by the limit rotation angle of the head (16) after separation from the reactor vessel (17) and the acceleration gained by the residual pressure in the reactor vessel (17).

The second optimum distance between the head (16) of reactor vessel (17) and the bearing ribs (5) for dampening the impact load at the second touch, given the rotation of the head (16) or its parts, is 200 to 800 mm. The minimum and maximum values are determined by the number of bearing ribs (5), their impact strength and ductility. If the impact strength of the bearing ribs (5) is equal, the smaller their number, the less distance is needed for the second touch, and the greater the number of bearing ribs (5), the greater the distance to the second touch can be.

The first and the second optimum distances between the head (16) of reactor vessel (17) and the bearing ribs (5) determine the shape of the surface of bearing ribs (5) facing the head (16) of reactor vessel (17). For smaller values of the optimum distance, surfaces of the bearing ribs (5) are made elliptical (18), as shown in FIG. 3.

With such a shape, the axial distances between the radial points (19 and 20) of the first and second touches on the bearing ribs (5) and their corresponding radial points (21 and 22) on the head (16) of reactor vessel (17) do not differ significantly. The first and the second paired touch points (19, 21 and 20, 22, respectively) on the radial ribs (5) are practically equidistant from the axial D-axis in the radial direction. For large values of the optimum distance, surfaces of bearing ribs (5) are made in the form of a straight line (23) with a constant angle of inclination relative to the axial D-axis, as shown in FIG. 4.

To maximize the stopping power of the bearing frame, two conditions should be met. The first condition is that the second optimum distance between the reactor vessel (17) head (16) and the bearing ribs (5) for shock absorption should be minimum 1.1 and maximum 8 times greater than the first optimum distance, which is determined by the conditions of rotation of the torn off head (16) and its large fragments. The second condition is that the radial location of the paired point (20, 22) of the second contact on the bearing rib (5) should be further from the axial D-axis than the radial location of the paired point (19, 21) of the first contact. This means that the paired point (19, 21) of the first contact of the torn off head on the bearing rib (5), i.e. the point of the first impact, should be closer to D-axis of symmetry than the point (20, 22) of the second contact, i.e. the point of the second impact as a result of turning the head or its large fragments during the movement.

The supporting functions of the bearing frame are performed by the outer upper bearing shell (9), the middle bearing shell (10), and the outer lower bearing shell (11) together with the inclined plates (13, 14), which accept and redistribute (align) static and dynamic power loads from the bearing ribs (5).

To redistribute the shock loads from the radial bearing ribs (5) in the azimuthal direction, the outer upper bearing shell (9) and the inner bearing shell (8), which fix the radial bearing ribs (5), are used in the bearing frame. The inner bearing shell (8) forms the central channel for the movement of the core melt and is a limiter for trapped large fragments of the reactor vessel (17) head (16), while the outer upper bearing shell (9) provides axial stability of the bearing ribs (5) during the entire interaction of the guide assembly with the core melt and the reactor vessel (17) head (16).

Due to the fact that the external upper bearing shell (9) performs the functions of damping and redistribution of loads from the bearing ribs (5), the following conditions should be met for its performance. The first condition is the strength and stability in the azimuthal direction, which is determined by L distance (as shown in FIG. 1) between the bearing ribs (5), which transmit the load from the head (16) of reactor vessel (17) to the outer upper bearing shell (9). The optimum L distance between the bearing ribs (5) along the perimeter of the outer upper bearing shell (9) is 0.7 to 1.3 m depending on the thickness of the bearing rib (5), and the diameter of the outer upper bearing shell (9), ranging from 4 to 6 m, has almost no effect on the value of L distance. The second condition is strength and stability in the axial direction, which imposes the following constraint on the bearing ribs (5): the ratio of length L1 of the bearing rib (5) in the radial direction to its average height L2 is close to 1, meaning that in the area of action and transfer of loads from the head (16) of reactor vessel (17) to the outer upper bearing shell (9), the bearing rib (5) in the radial-axial plane should fit into a square with sides L1=L2, or be trapezoidal in projection L1, L3, as shown in FIG. 1, with the long base (or side of the trapezoid) arranged vertically. Thus, bearing ribs (5) with inclined plates (13, 14), outer upper bearing shell (9), middle bearing shell (10), and outer lower bearing shell (11) provide damping of shock load from the detached head (16) of reactor vessel (17) with core melt or from detached sectors of destroyed head (16) with fragments of internals, and, therefore, provide braking and blocking of large fragments of the reactor vessel (17) and its internals, ensuring sequential enter of the core melt, internals debris, and reactor vessel (17) head (16) into the core catcher.

The upper inclined plate (13) and the lower inclined plate (14) perform the stabilizing functions of the bearing frame. The upper inclined plate (13) connects the middle bearing shell (10) to the conical head (15). The lower inclined plate (14) connects the outer upper bearing shell (9) to the conical head (15). The inclined bearing plates (13, 14) provide axial stability of the bearing ribs (5) during the redistribution of shock mechanical loads and are guiding elements that provide a given direction of molten core flow from the reactor vessel (5) into the core catcher.

The angle of bearing plates (13, 14) in the radial direction is chosen so as to provide equal area at the entrance to each sector formed by the inclined plate (13, 14) and the two bearing ribs (5), and at the exit from each sector. In this case, as shown in FIG. 4, the flow area in the direction of the core melt flow will be horizontal (24) at the entrance to the sector, and vertical (25) at the exit from the sector, which determines the position of the horizontal bearing plates in the base of the bearing frame. To ensure the required throughput capacity of the bearing frame, the flow area of sectors is selected based on the specified flow rate of the first salvo portion of the core melt entering the catcher during the lateral melt-through of the reactor vessel (17).

Depending on the thickness and throughput capacity of the sectors' flow areas, an additional inclined plate can be installed between the upper inclined plate (13) and the lower inclined plate. The inclined plates (13, 14) due to their own destruction at each level provide an increase in the flow area of the bearing frame sectors and, as a consequence, provide an increase in the flow rate when the core melt flows from the reactor vessel (5) into the catcher. Thus, the inclined plates (13, 14) and radially oriented bearing ribs (5) provide axial stability of the bearing ribs (5) during redistribution of shock mechanical loads and provide a given direction of core melt flow from the reactor vessel (17) into the core catcher.

The channel-forming functions of the bearing frame together with the inclined plates (13, 14) are performed by the radially oriented bearing ribs (5), which ensure the throughput capacity of the flow area of sectors during the lateral melt-through of the reactor vessel (17). When heated with the core melt, the reactor vessel (17) head (16), until the melt-through of the vessel side wall or until the head tears off, experiences significant thermomechanical deformations, as a result, the reactor vessel (17) head (16) moves towards the bearing frame due to plastic deformations and starts contacting with the bearing ribs (5).

Contact of the head (16) of reactor vessel (17) with the bearing ribs (5) leads to the development of one of two scenarios. In the first case, the head (16) ruptures in the area located between the bearing ribs (5), or crashes with the formation of a crack, and the melt flows out through the rupture zone. In the second case, the head (16) does not crash, and continues deforming plastically in the space between the radial bearing ribs (5). The second case is the most dangerous, since the reactor vessel (17) head (16) in this case is capable of completely blocking the flow area of the bearing frame sectors and blocking the core melt in the side lateral melt-through of the reactor vessel (17). In case of such blocking, the core melt, having no escape, will destroy the dry shield filled with serpentine concrete and the civil structures of reactor cavity. To avoid blocking of the flow area of bearing frame sectors by the head (16) of reactor vessel (17), the inclined plates (13, 14) are mounted below the border which the outer surface of the reactor vessel (17) head (16) can reach without destruction in the sectors between the radial bearing ribs (5). This boundary changes from the periphery to the center of the head (16) and depends on both the distance between the bearing ribs (5) and their thickness. The optimal ratio of the total thickness of bearing ribs (5) to the length of the circumference of outer upper bearing shell (9) is 4 to 8%, and the number of bearing ribs (5) varies from 8 to 16. In this case, the installation depth of the inclined plates (13, 14) ranges from 200 to 400 mm from the outer edge of the bearing rib (5) facing the reactor vessel (17) head (16), in the critical section having the lowest boundary that the outer surface of the vessel (17) head (16) can reach without breaking in the sectors between the radial bearing ribs (5). Thus, the inclined plates (13, 14) and radially oriented bearing ribs (5) provide the throughput capacity of the sectors' flow area during the lateral melt-through of the reactor vessel (17) and, consequently, the protection of the structural and serpentine concrete of the reactor cavity from interaction with the melt.

The protective functions of the bearing frame are performed by the middle bearing shell (10), which ensures that the outer upper bearing shell (9) is distanced from the impact of the leaking core melt. Depending on the thickness, 1 to 2 middle bearing shells (10) may be additionally installed, that will provide, through their own failure, protection for the outer upper bearing shell (9) and the outer lower bearing shell (11). Thus, the middle bearing shell (10) protects the upper bearing shell from destruction by the core melt, and, as a result, protects the structural and serpentine concretes of the reactor cavity from interaction with the melt.

The use of a bearing frame as part of the guide assembly provides a gradual flow of corium (melt) after reactor failure or melt-through into the core catcher and prevents large debris from the reactor vessel internals, fuel assemblies, and reactor vessel head from falling into the core catcher. As a result, this improved the efficiency of lozalization and cooling of the nuclear reactor core melt by eliminating an instantaneous melt trapping.

### Sources of Information

1. RF patent No. 2253914, IPC G21C 9/016, priority dated 18.08.2003

2. Corium localizing device, 7th International Research and Training Conference “Safety assurance of NPP with VVER”, OKB Gidropress, Podolsk, Russia, May 17-20, 2011.

3. RF patent No. 2576516, IPC G21C 9/016, priority dated 16.12.2014;

4. RF patent No. 2576517, IPC G21C 9/016, priority dated 16.12.2014;

5. RF patent No. 2575878, IPC G21C 9/016, priority dated 16.12.2014.

1. A guide assembly (1) of a nuclear reactor corium localizing and cooling system mounted under the reactor vessel and resting on the cantilever truss, containing a cylindrical part (2), a conical part (3) with an opening (4) made therein, with their walls coated with heat-resistant and fusible material and divided into sectors by bearing ribs (5) arranged radially relative to the opening (4), characterized in that it additionally contains a bearing frame consisting of an outer upper bearing ring (6), outer lower bearing ring (7), inner bearing shell (8), outer upper bearing shell (9), middle bearing shell (10) divided into sectors by bearing ribs (5), outer lower bearing shell (11), support ribs (12), base (26), an upper inclined plate (13) connecting the conical head (15), bearing ribs (5) and the middle bearing shell (10), a lower inclined plate (14) connecting the conical head (15), bearing ribs (5), the middle bearing shell (10) and the outer upper bearing shell (9).

2. A guide assembly (1) of a nuclear reactor corium localizing and cooling system according to claim 1 characterized in that it additionally contains an inclined plate installed between the upper inclined plate (13) and the lower inclined plate (14).

3. A guide assembly (1) of a corium localizing and cooling system according to claim 1 characterized in that it additionally contains 1 to 2 middle bearing shells (10).
